(19) United States
(12) Patent Application Publication
(10) Pub. No.: US 2025/0102235 A1
(43) Pub. Date: Mar. 27, 2025

(54) THERMOCHEMICAL ENERGY STORE AND SYSTEM COMPRISING THE THERMOCHEMICAL ENERGY STORE

(71) Applicant: Bernhard KÖNIG, Pabneukirchen (AT)

(72) Inventor: Bernhard KÖNIG, Pabneukirchen (AT)

(21) Appl. No.: 18/834,074

(22) PCT Filed: Jan. 28, 2022
(86) PCT No.: PCT/EP2022/052077

§ 371 Date: Jul. 29, 2024

(51) Int. Cl. F28D 20/00; F24D 11/02

(52) U.S. Cl. CPC F28D 20/003; F24D 11/02; F28D 2020/0065

(57) ABSTRACT

A thermochemical energy storage, a system including the thermochemical energy storage, and uses of the thermochemical energy storage. The thermochemical energy storage includes one or more thermochemical cells each containing a container with a reaction phase and a gas phase. Providing a technically simple thermochemical energy storage with low maintenance requirements, the container of the one or more thermochemical cells each have a fluid inlet and fluid outlet connected to the primary heat medium circuit, each of which opens into the gas phase in the container.

### CROSS-REFERENCE TO RELATED APPLICATIONS

The present application is a national phase application of PCT Application No. PCT/EP2022/052077, filed Jan. 28, 2022, entitled “THERMOCHEMICAL ENERGY STORE AND SYSTEM COMPRISING THE THERMOCHEMICAL ENERGY STORE”, which is incorporated by reference in its entirety.

### BACKGROUND OF THE INVENTION

### 1. Field of the Invention

The present invention relates to a thermochemical energy storage, as well as uses of the thermochemical energy storage.

### 2. Description of the Related Art

From the prior art, thermochemical energy storages are known, which include a reactant and a solvent, whereby supplying the solvent to the reactant, thermal energy is extracted, and thus, the thermochemical energy storage is discharged. By supplying thermal energy to the reactant, in turn, solvent can be removed from it, thereby charging the thermochemical energy storage.

From the prior art (DE 31 13 026 A1), a thermochemical heat storage system is known, in which energy is supplied to a solution of a salt or hydroxide in a solvent for the storage of heat, causing the solvent to be expelled from the solution. This expulsion of the solvent takes place under significantly reduced pressure (˜0.1 bar), so that during the expulsion of the solvent, the salt or hydroxide is simultaneously precipitated into a foamy, porous phase above the solution.

By crystallizing the hydroxide in the foam-like, porous phase, rapid absorption of the solvent can be achieved and thus a particularly fast-reacting heat release can be ensured. However, to provide the negative pressure that is necessary to form the foam-like phase, such systems must be constructed in a complex, pressure-tight and massive manner, which significantly increases the maintenance effort and the susceptibility to errors and thus also the operating costs.

From the prior art (EP 3 674 646 A1), also thermochemical energy storages are known, in which water, as a reactant in the form of water vapor, is introduced into a reactor to be absorbed in a bed of reactive material and react with it, releasing thermal energy. The supply of water vapor and the flow through the reactive bed require the prior conversion of water into vapor and a complex construction of the reactor to be efficiently absorbed by the reactive material. Such energy storage systems, are costly to manufacture and maintenance-intensive, leading to high ongoing costs.

### SUMMARY OF THE INVENTION

The present invention, therefore, aims to improve a thermochemical energy storage of the type mentioned above in such a way that it is technically simple and has low maintenance requirements.

The invention solves the stated problem through the thermochemical energy storage according to the present technology.

The thermochemical energy storage of the present invention comprises one or more thermochemical cells, wherein each of the one or more thermochemical cells includes a container in which, in at least one operating state, a reaction phase and a gas phase above the reaction phase are formed. The reaction phase comprises at least one reactant and a solvent, while the gas phase comprises a carrier gas enriched with the solvent.

According to the invention, the thermochemical energy storage also has at least one primary heat medium circuit with a heat transfer medium, the heat transfer medium serving to introduce thermal energy into the thermochemical energy storage or to remove thermal energy from the thermochemical energy storage.

Furthermore, in the thermochemical energy storage according to the invention, a fluid circuit is provided for diverting the carrier gas from at least one of the thermochemical cells and introducing the carrier gas into at least one of the thermochemical cells. The fluid circuit is preferably in fluidal contact respectively fluidal exchange with the gas phase in the at least one thermochemical cell and can thus be used to divert a carrier gas enriched with solvent from the thermochemical cell. At the same time, the fluid circuit can also reintroduce solvent-depleted carrier gas back into the gas phase in the at least one thermochemical cell.

According to the invention, also a solvent line is provided for introducing solvent into the reaction phase of at least one of the thermochemical cells.

According to the invention, the reactant is selected from a group consisting of salts, hydroxides, carbonates, and ionic liquids, so that upon supplying the liquid solvent from the condensate container into the reaction phase of at least one of the thermochemical cells, thermal energy is released to the heat transfer medium in the primary heat medium circuit due to an exothermic reaction of the reactant with the solvent. When heat is supplied to the reaction phase of at least one of the thermochemical cells via the heat transfer medium, solvent is transferred from the reaction phase to the gas phase.

According to a preferred embodiment of the invention, the reactant can be sodium hydroxide (NaOH) and the solvent can be water. According to another embodiment, the reactant can also be another hygroscopic salt, a hydroxide, a carbonate, or an ionic liquid that undergoes an exothermic reaction with the solvent. In another embodiment, the reactant can be strontium bromide or potassium carbonate.

In general, within the scope of the invention, a reactant is referred to as a substance that releases heat in the form of an exothermic reaction upon dissolution in a solvent. The reaction is preferably a (completely) reversible chemical reaction that can be reversed by removing the solvent (especially by desorption, evaporation, etc.) from the solution. Both the reactant and the solvent preferably undergo no irreversible chemical changes during the various operating states of the thermochemical storage (especially during charging and discharging). Therefore, upon reversing the solution, the reactant and solvent can be reused as starting materials for the exothermic reaction.

According to the invention, the container of at least one of the thermochemical cells has a fluid inlet and fluid outlet, each connected to the fluid circuit, and both ending in the gas phase in the container. Through the fluid inlet and fluid outlet in the container, each connected to the fluid circuit and ending in the gas phase, a fluid exchange in the container and with the fluid circuit can be ensured in a technically simple manner. The carrier gas enriched with solvent from the gas phase is directed to the condenser via the fluid circuit, removing the solvent from the carrier gas. Simultaneously, the solvent-depleted carrier gas can be reintroduced into the gas phase through the fluid inlet to become enriched with solvent from the reaction phase. The supply of carrier gas directly into the gas phase via the fluid circuit offers the advantage of keeping the solvent concentration of the carrier gas in the gas phase consistently low. This reduces the temperature necessary for expelling solvent from the reaction phase. Maintaining a low solvent concentration is crucial for the proper and efficient operation of the thermochemical energy storage because an increase in solvent concentration or reaching the saturation vapor pressure in the gas phase would elevate the evaporation temperature in the reaction phase and consequently a higher amount of heat or temperature would have to be supplied to the reaction phase through the primary heat medium circuit, negatively impacting the system's efficiency.

Fluid inlet and fluid outlet can be designed both separately and as a common fluid inlet and outlet, with the latter being particularly advantageous for very compact thermochemical cells with limited space, due to a more compact design.

According to one embodiment of the invention, the thermochemical energy storage may include a condenser in the fluid circuit for condensing solvent from the carrier gas. The condenser can serve to deplete solvent from the carrier gas of the fluid circuit and reliably condense solvent from the carrier gas, which was previously enriched with solvent in the gas phase. In this way, the solvent can be technically easily and reliably removed from the gas phase, allowing for the reuse of the carrier gas for reintroduction into a thermochemical cell.

According to one embodiment of the invention, the thermochemical energy storage may further include a condensate container for storing the solvent condensed from the carrier gas in the condenser. This ensures that no solvent is lost during the operating states of the thermochemical energy storage, and the recovered solvent can be reused for the thermal discharge of the energy storage. Consequently, there is no need to provide fresh solvent for supply to the thermochemical cells, further reducing the operating costs of the energy storage.

Additionally, the solvent line can be connected to the condensate container in such a way that solvent can be directly supplied from the condensate container to a thermochemical cell. A complete solvent loop can be established, wherein the solvent captured in the condensate container and recovered from the carrier gas by the condenser can be reintroduced to at least one thermochemical cell, especially in its reaction phase, via the solvent line.

According to one embodiment of the invention, the fluid circuit may be closed to the environment and have ambient pressure. The use of a fluid circuit closed to the environment ensures that neither solvent nor reactant is lost to the surroundings, saving feedstock on the one hand, and avoiding potential environmental burdens on the other. By sealing the system at ambient pressure, the system can also be characterized by technical simplicity, as there is no need to maintain a vacuum in the system, which would require high demands on tightness and maintenance. This results in a cost-effective system with low maintenance requirements.

It is generally noted that ambient pressure is understood as the average atmospheric pressure at any location, with deviations from the currently prevailing air pressure within the usual range, such as due to atmospheric pressure fluctuations caused by weather, altitude, etc., being disregarded. At sea level, ambient pressure corresponds to atmospheric pressure of 1 bar. Similarly, the differential pressure required for circulating fluid in the fluid circuit by a pump or circulation fan is not understood as pressurizing the entire system.

According to a preferred embodiment, the pressure in the thermochemical cell(s) and in the fluid circuit is between 80% and 120% of ambient pressure, especially between 90% and 110% of ambient pressure, particularly preferably between 95% and 105% of ambient pressure.

According to another embodiment of the invention, the fluid inlet has an inlet opening, and the fluid outlet has an outlet opening, with both the inlet and outlet openings provided in the top of the container of the at least one thermochemical cell. By providing an inlet opening in the top of the container, the carrier gas stream from the fluid circuit can be directed directly into the gas phase in any operating state of the thermochemical cell, ensuring reliable exchange of the carrier gas in the thermochemical cell. The continuous exchange of the carrier gas in the gas phase enables a reliable removal of solvent, thereby increasing the efficiency of the thermochemical storage.

According to another preferred embodiment, the fluid inlet may have a first fluid guide section, wherein the first fluid guide section is designed to deflect the carrier gas guided in the fluid circuit towards the reaction phase. The first fluid guide section of the fluid inlet directs the carrier gas entering the container of the thermochemical cell before entering the container through the inlet opening in such a way that it flows towards the reaction phase inside the container. By diverting the carrier gas towards the reaction phase, the flow conditions in the gas phase can be influenced to ensure efficient absorption of solvent emerging from the reaction phase.

In particular, according to another embodiment, the first fluid guide section may be designed such that directing the incoming carrier gas on the fluid guide section forms a turbulent airflow in the gas phase. The turbulent airflow can improve the exchange of carrier gas enriched with solvent from the thermochemical cell, as the formation of dead zones or bubbles in the gas phase, which can occur at edges or corners in the case of laminar flows, is avoided. This can further enhance the efficiency of the thermochemical storage.

According to another embodiment, the fluid outlet may have a second fluid guide section, wherein the second fluid guide section is designed to guide the carrier gas from the reaction phase into the fluid circuit. By suitably designing the second fluid guide section, the flow pattern of the gas phase inside the housing of the thermochemical cell can be advantageously influenced, ensuring contact between the carrier gas and the reaction phase in a way that increases the efficiency of absorbing solvent from the reaction phase into the gas phase.

According to another embodiment, the first fluid guide section, in longitudinal section, may have at least one tangent that penetrates the respective thermochemical cell from its top towards its bottom. In particular, at least one tangent of the contour of the first fluid guide section intersects the reaction phase, directing carrier gas flowing over the first fluid guide section towards the reaction phase.

In this context, a longitudinal section is understood as a sectional view through the respective thermochemical cell, where the longitudinal section intersects both the reaction phase of the thermochemical cell and the fluid inlet and fluid outlet. The longitudinal section runs parallel to two opposite side walls of the thermochemical cell and is perpendicular to the bottom of the thermochemical cell.

According to another embodiment, the second fluid guide section may also have at least one tangent in longitudinal section, penetrating the respective thermochemical cell from its top towards its bottom. Again, at least one tangent of the contour of the second fluid guide section may intersect the reaction phase, thereby supporting the guidance of the carrier gas from the reaction phase towards the fluid outlet and into the fluid circuit.

In other words, according to the above embodiments, the first and second fluid guide sections, in longitudinal section, can have at least one tangent with a normal component to the interface of the reaction phase and gas phase.

According to another embodiment, the first fluid guide section directly connects to the inlet opening in the top of the thermochemical cell. Thus, the diversion and guidance of the carrier gas towards the reaction phase can advantageously take place directly upon entry of the carrier gas from the fluid circuit into the container. Preferably, the fluid guide section, according to the above-described embodiment, immediately following the inlet opening, has a tangent that penetrates or intersects the thermochemical cell towards the reaction phase. This ensures reliable guidance of the carrier gas towards the reaction phase without further deflections.

According to another embodiment, the second fluid guide section directly connects to the outlet opening in the top of the thermochemical cell. As described earlier for the first fluid guide section in the fluid inlet of the thermochemical cell, the arrangement of the second fluid guide section immediately following the fluid outlet ensures a reliable guidance of the carrier gas from the reaction phase towards the outlet opening.

According to another embodiment, a circulation fan may be arranged in the fluid circuit. The circulation fan can assist in the forced conveyance of the carrier gas in the fluid circuit and allow for targeted control of the flow velocity of the carrier gas inside the thermochemical cell. This ensures a more reliable exchange of carrier gas, not solely relying on the natural convection of the carrier gas.

According to another embodiment of the invention, each of the one or more thermochemical cells may have at least one heat exchanger connected to the primary heat medium circuit, wherein the heat exchanger is in thermal contact with the reaction phase. This allows direct supply of thermal energy to the reaction phase via the primary heat medium circuit to expel solvent from it and charge the thermochemical cell. Conversely, thermal energy can be extracted from the thermochemical cell when it is discharged by supplying solvent to the reaction phase.

According to one embodiment, the heat exchanger may be designed as a tube heat exchanger inside the thermochemical cell, wherein the tube heat exchanger is arranged within the reaction phase of the respective thermochemical cell. In particular, the tube heat exchanger may have tubes for guiding the heat transfer medium, and the tubes are arranged in the reaction phase in a way that they are covered by the solution in the reaction phase in all operating states. Preferably, the tube heat exchanger may be configured as a spiral made of one or more tubular hoses, where the hoses are made of a material inert to the reaction phase, preferably PTFE.

According to another embodiment, the heat exchanger can be a surface heat exchanger, which is arranged above the bottom and/or on at least one side wall of the respective thermochemical cell. In particular, the plate heat exchanger may be configured as a flat plate heat exchanger.

According to another embodiment, the thermochemical energy storage may have a secondary heat medium circuit, through which the condenser can be connected to a low-temperature source. Connecting the condenser to a low-temperature source is particularly advantageous to increase the efficiency of the condenser, as this prevents or at least reduces the heating of the condenser and thus loss of condensation capability.

In this context, any heat reservoir with a sufficiently low temperature suitable for efficient condensation of the solvent from the carrier gas can serve as a low-temperature source. According to one embodiment, such a heat reservoir can be the ambient air, where the condenser is connected to an air heat exchanger via the secondary heat medium circuit, which is cooled by the ambient air (especially outdoor air).

It has proven particularly advantageous in this context when the condenser can be connected to one or more of the thermochemical cells as a low-temperature source via the secondary heat medium circuit. Since the thermochemical cells act as a large heat reservoir, especially in the uncharged state, they are suitable as a low-temperature source for the condenser. The associated heat input from the condenser to the thermochemical cell can also be advantageously used to preheat the thermochemical cell. For example, during the charging of a first cell with thermal energy via the primary heat medium circuit, a second thermochemical cell can be preheated via the secondary heat medium circuit with the waste heat from the condenser, so that immediately after the complete charging of the first cell, the charging of the second cell can begin, allowing for a faster heating of the second cell. This way, less thermal energy is lost during the charging of thermochemical cells, and the efficiency of the thermochemical storage can be further improved.

According to another embodiment, a filling level sensor can be provided on the container of the thermochemical cell. The level sensor can determine the level height or the volume of solution (solvent+reactant) inside the container, allowing an inference about the charging state of the respective thermochemical cell. The level sensor preferably has no physical contact with the solution, ensuring a long lifespan with low maintenance. In particular, the level sensor is configured as an electromagnetic level sensor, more preferably as a capacitive level sensor, which is attached to the outside of the container and determines the level inside the container based on the change in the electromagnetic field or the change in relative permittivity.

According to another embodiment, the thermochemical energy storage may include a safety tank with a leakage detector, where the one or more thermochemical cells are accomodated in the safety tank. This configuration enhances safety by capturing any leaked solution from the thermochemical cell in the safety tank and detecting it through the leakage detector. The occurrence of a solution leak can thus be reliably detected, allowing for timely implementation of necessary steps or maintenance work.

According to another embodiment of the invention, the primary heat medium circuit may include controllable valves to alternately connect one or more thermochemical cells, either directly or indirectly through heat exchangers, with a heat source or heat sink. In one operational state, where a thermochemical cell is being charged, the valves can be configured to connect the heat medium circuit to both a heat source (e.g., solar panel, solid fuel heating system) and the thermochemical cell to be charged. This allows thermal energy to be supplied from the heat source to the thermochemical cell via the heat medium circuit. In another operational state, where a thermochemical cell is being discharged, the valves can be configured to connect the heat medium circuit to both the thermochemical cell to be discharged and the heat sink (e.g., heating system or another heat consumer), allowing thermal energy from the thermochemical cell to be supplied to the heat sink. In further operational states, the valves can be configured to disconnect both the heat source or heat sink and one or more thermochemical cells from the heat medium circuit.

Additionally, it should be noted that heat sources and heat sinks, as per the present invention, can be connected to the primary heat medium circuit either directly or indirectly (such as through a heat exchanger). For example, a building heating system acting as a heat sink may include a heat exchanger connectable to the primary heat medium circuit, and this heat exchanger may be coupled to a heating circuit within the building heating system. Similarly, a heat sink like a solar panel may include a heat exchanger connected to the primary heat medium circuit. The described principle can be applied to all types of heat sources and heat sinks.

Similarly, according to another embodiment of the invention, the secondary heat medium circuit may include controllable valves to connect one or more of the thermochemical cells to a low-temperature source, especially to the condenser.

According to another embodiment, the thermochemical energy storage may include a control device programmed to control the valves of the primary and/or secondary heat medium circuits based on the state of charge of the thermochemical cells for the extraction or supply of thermal energy. In particular, the control unit can be connected to the valves in the primary and/or secondary heat medium circuits and control them individually or separately. This can further enhance the safety and reliability of the thermochemical storage by ensuring that energy is not extracted from a fully discharged cell or supplied to a fully charged cell based on the control of the valves depending on the state of charge of the cells.

In the context of the present invention, a fully charged thermochemical cell is understood to be a thermochemical cell in which a predetermined concentration threshold of the solvent concentration in the solution has been undercut due to the supply of thermal energy to the reaction phase, or conversely, a concentration threshold of the reactant concentration has been exceeded. Alternatively, a fully charged thermochemical cell can also be characterized by falling below a predetermined fill level threshold of the solution fill level in the container of the thermochemical cell.

In the context of the present invention, a fully discharged thermochemical cell is understood to be a thermochemical cell in which a predetermined fill level threshold of the solution fill level in the container of the thermochemical cell has been exceeded due to the supply of solvent to the reaction phase. Alternatively, a fully discharged thermochemical cell can also be characterized by exceeding a predetermined concentration threshold of the solvent concentration in the solution, or by falling below a concentration threshold of the reactant concentration.

According to one embodiment of the invention, the control device may be further programmed to control the valves of the primary heat medium circuit for charging a partially or not charged thermochemical cell when a predetermined threshold temperature of a heat source connected to the primary heat medium circuit is exceeded. In particular, the control device may be connected to a temperature sensor of the heat source to monitor its temperature. The control unit can reliably determine when the temperature of the heat source is sufficiently high to achieve the temperature required for solvent vaporization in the reaction phase when thermal energy is supplied from the heat source to the reaction phase. This can prevent thermal energy from the heat source being supplied to the thermochemical cell without leading to the charging of the thermochemical cell, but only heating the reaction phase. This can reduce energy losses and increase the efficiency of the thermochemical storage.

According to one embodiment of the invention, the control device may be programmed to store and/or monitor the charging status of the thermochemical cells. In the case of available thermal energy from a heat source, the control device can then continuously control the valves to connect an uncharged or only partially charged thermochemical cell to the heat source for charging.

According to another embodiment, the control device may be connected to sensors and/or a control unit of a heat source to determine the amount of heat available from the heat source for charging the thermochemical cells. After determining the heat amount, the control device can select the thermochemical cell for charging or control the valves to connect the cell to the heat source, which can achieve the most advantageous improvement in the charging state by supplying the determined heat amount and/or which can fully absorb the determined heat amount. This helps improve the energy efficiency of the thermochemical storageby avoiding or reducing heat losses during the charging of thermochemical cells.

In another embodiment, the control device may be further programmed to read the fill level sensors of the thermochemical cells and, upon falling below a predetermined fill level threshold in a thermochemical cell, output a signal indicating the complete charging of that thermochemical cell. Therefore, the control unit is preferably connected to the fill level sensors of one or more thermochemical cells to detect and possibly monitor the fill levels of the thermochemical cells. The outputted signal can serve, for example, to inform a user when a thermochemical cell has been fully charged. Alternatively, the signal can be fed to a control unit of the heat source so that the heat supply to the thermochemical energy storage is stopped, or the heat can be supplied to another consumer or another energy storage.

In another embodiment, the control device may be further programmed, in the case of a fully charged thermochemical cell, to determine the temperature spread of the heat transfer medium during the charging of the thermochemical cell, and when falling below a predetermined temperature spread threshold, control the valves to disconnect the fully charged thermochemical cell from the primary heat medium circuit. For example, if the control device determines the complete charging of the thermochemical cell by falling below a fill level threshold or a predetermined concentration threshold of the solvent concentration in the solution, the thermochemical cell can still be charged until the temperature spread of the heat transfer medium falls below a predetermined temperature spread threshold, i.e., when no more thermal energy is absorbed from the thermochemical cell. This is especially the case when the solvent concentration in the thermochemical cell has fallen below a certain concentration threshold, and no more solvent can be removed from the reaction phase by supplying additional thermal energy. Monitoring the temperature spread can reliably determine when a thermochemical cell is fully charged, and by controlling the valves, it can be disconnected from the heat source or the primary heat medium circuit.

The temperature spread of the heat transfer medium during the charging of a thermochemical cell refers to the temperature difference between the temperature of the heat transfer medium before entering a thermochemical cell and the temperature of the heat transfer medium after exiting the thermochemical cell.

According to another embodiment of the invention, the control device can be further programmed, upon receiving a signal to release heat from the energy storage to a heat sink, to control a pump in a solvent line to supply solvent from the condensate container to the reaction phase of a charged or partially charged thermochemical cell. When the solvent is absorbed in the reaction phase, thermal energy is released through the chemical reaction with the reactant, which can be supplied to the heat sink via the primary heat medium circuit. As a result of the solvent uptake in the reaction phase, the solution level in the container or the solvent concentration in the solution increases, with a decreasing state of charge of the thermochemical cell.

According to another embodiment of the invention, the control device can be further programmed to control the flow rate of heat transfer medium in the primary heat medium circuit by controlling a heat transfer medium pump in the heat medium circuit. This can be particularly advantageous to maintain the outlet temperature of the heat source in a favourable range and to regulate and/or limit the amount of energy supplied to the thermochemical cell, for example, to keep the temperature supplied to the thermochemical cell in a preferred range. An improved lifespan and maintenance-free operation of the energy storage can be achieved that way.

The invention further aims to provide a system consisting of an energy storage and a heat pump, characterized by high system efficiency and reduced power consumption of the heat pump.

The stated objective is further achieved by a system comprising a thermochemical energy storage according to any of claims 14 to 18 and a heat pump. The heat pump includes a condenser for delivering energy to a heat sink and an evaporator for receiving energy from a heat source. The evaporator of the heat pump is coupled to the primary heat medium circuit of the thermochemical energy storage as a heat sink. Such a system can significantly increase the efficiency of the heat pump during the cold season by raising the temperature of the heat pump's evaporator. Furthermore, the elevation of the temperature level of the evaporator is associated with low energy input. This allows the thermochemical energy storage of the present invention, in combination with the heat pump, to contribute to the year-round efficient supply to a heat sink (such as a household with building and/or hot water heating) with minimal energy usage. The use of additional heating means (such as direct heating using electrical power) can be avoided or reduced, enhancing the overall system efficiency of heat pumps, and creating a year-round, self-sufficient heating system independent of external energy sources.

According to another embodiment of the system, the heat pump may additionally include a heat exchanger coupled to the evaporator, which is connected to the primary heat medium circuit of the thermochemical energy storage. In this way, either an existing heat exchanger in the heat pump can be connected to the primary heat medium circuit in a technically simple manner, or an additional heat exchanger on the evaporator side can be provided, which is coupled to it by being connected upstream of the evaporator. This may be particularly suitable for use in air heat pumps, where the ambient air entering the evaporator has an inefficient temperature level, and thus, the refrigerant of the heat pump is preheated by the heat exchanger.

The thermochemical energy storage according to the present technology is advantageously suitable as a building heating system, for example, by connecting a heat exchanger of the building heating system's heat medium circuit directly to the primary heat medium circuit of the thermochemical energy storage.

Equally, the thermochemical energy storage according to the present technology is also advantageously suitable for use as a buffer storage, especially for buffering thermal energy from power plants, district heating, solar collectors, or photovoltaic systems. The thermochemical energy storage can be charged in the case of surplus energy, storing thermal energy for later release.

Equally, a system according to the present technology is particularly suitable for use as a building heating system. By using the system according to the invention as a building heating system, an especially efficient heating system can be provided, utilizing a heat pump.

### BRIEF DESCRIPTION OF THE DRAWINGS

In the following, preferred embodiments of the invention are described in more detail with reference to the drawings. The drawings show:

FIG. 1 a schematic view of a thermochemical energy storage with four thermochemical cells according to a first embodiment of the invention,

FIG. 2 a schematic detailed view of a thermochemical cell of the thermochemical energy storage according to a second embodiment during the charging of the thermochemical cell,

FIG. 3 a schematic detailed view of a thermochemical cell of the thermochemical energy storage according to the first embodiment during the discharging of the thermochemical cell,

FIG. 4 a schematic view of a thermochemical energy storage according to a second embodiment of the invention.

### DETAILED DESCRIPTION

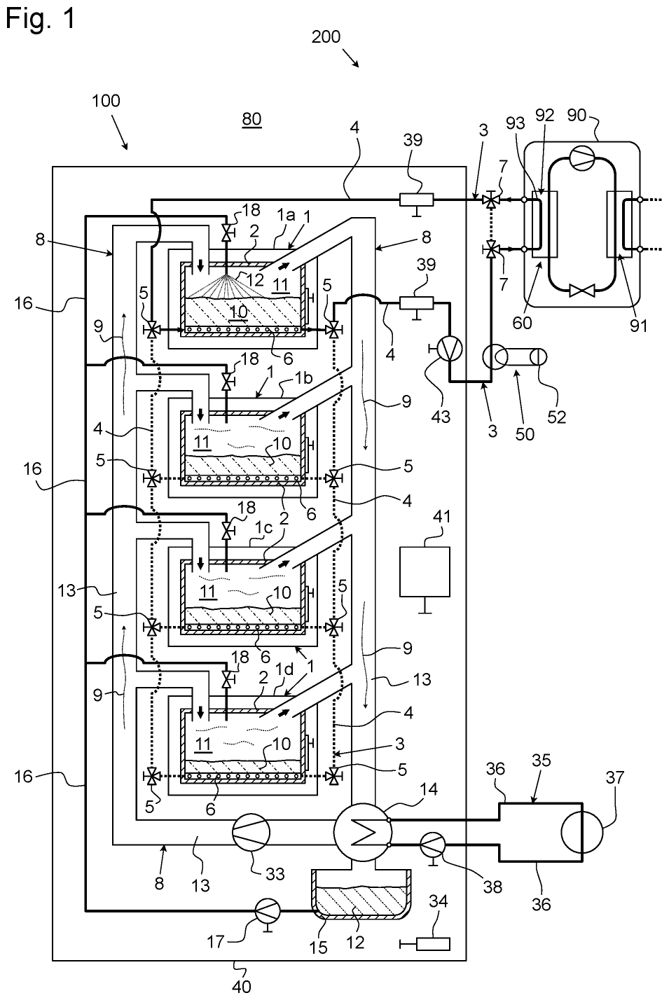

According to FIG. 1, a thermochemical energy storage 100 according to a first embodiment of the invention is shown. The thermochemical energy storage 100 has four thermochemical cells 1, in particular, a first, second, third, and fourth thermochemical cell 1a, 1b, 1c, 1d, wherein the thermochemical cells 1 each comprise a container 2.

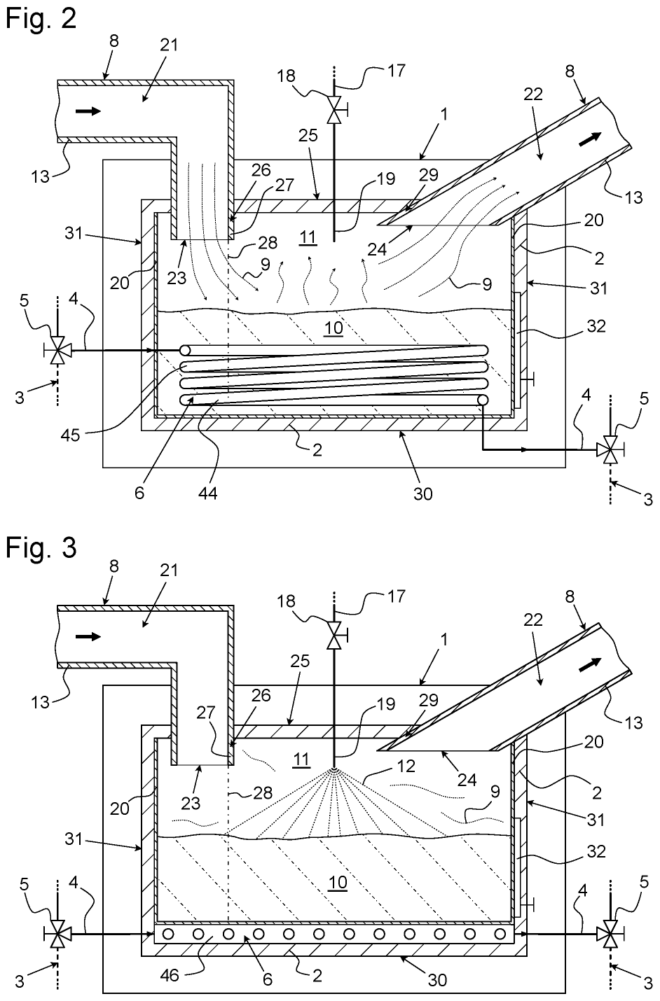

The first embodiment of the thermochemical energy storage 100 is described below with reference to FIG. 1. For a detailed description of the structure of the thermochemical cells 1 in the thermochemical energy storage 100, reference is made to FIGS. 2 and 3, as well as the further explanations below.

Inside the container 2 of each thermochemical cell 1, there is a reaction phase 10 and a gas phase 11. The reaction phase 10 consists, at least in one operating state, of a solution of a reactant and a solvent 12. The gas phase 11, in turn, is arranged in the container 2 above the reaction phase 10 and comprises, in at least one operating state, a carrier gas 9 enriched with solvent 12. In another operating state, the gas phase 11 may consist essentially only of carrier gas 9 and may be only marginally or not at all enriched with solvent from the reaction phase 10.

According to a preferred embodiment of the invention, the reactant is NaOH, and the solvent 12 is water. According to further embodiments of the invention, the reactant may also be selected from a group consisting of salts, hydroxides, carbonates, and ionic liquids.

Reactant and solvent 12 are, in any case, matched such that, upon supplying solvent 12 to the reactant in the reaction phase 10 in one of the thermochemical cells 1, thermal energy is released due to an exothermic reaction of the reactant with the solvent 12. This released thermal energy can then be extracted from the respective thermochemical cell 1 and supplied to a heat sink 60, corresponding to the operational state of discharging the thermochemical energy storage 100.

Equally, reactant and solvent 12 are selected such that, upon supplying thermal energy from a heat source 50 to the solution in the reaction phase 10, solvent 12 is released from it to the gas phase 11, corresponding to the operational state of charging the thermochemical energy storage 100.

During the discharging of the thermochemical energy storage 100, or particularly of a thermochemical cell 1, the concentration of the reactant in the reaction phase 10 of the corresponding thermochemical cell 1 decreases due to the addition of solvent 12. During the charging of the thermochemical energy storage 100, or the thermochemical cell 1, the concentration of the reactant in the reaction phase 10 of the thermochemical cell 1 increases due to the release of solvent 12 to the gas phase 11.

The thermochemical energy storage 100 further comprises a primary heat medium circuit 3 in which a heat transfer medium circulates, and the primary heat medium circuit 3 is connected to the thermochemical cells 1 for the extraction and introduction of thermal energy. As shown in FIG. 1, the heat transfer lines 4 of the primary heat medium circuit 3 are each connected to a heat exchanger 6 in each thermochemical cell 1 via valves 5. This allows the heat transfer medium in the primary heat medium circuit 3 to circulate through the heat exchanger 6 inside the thermochemical cell 1, absorbing or releasing thermal energy to and from it.

As shown in FIG. 1, only the valves 5 of the first thermochemical cell 1a are open, thereby connecting only the first thermochemical cell 1a to the primary heat medium circuit 3. The additional thermochemical cells 1b, 1c, 1d are separated from the primary heat tran medium sfer circuit 3, as indicated by dashed heat transfer lines 4. However, they can be connected to the heat medium circuit 3 by opening the respective valves 5. Conversely, the first thermochemical cell 1a can be disconnected from the primary heat medium circuit 3 by closing the valves 5, although this is not explicitly shown in the figures.

Additionally, the primary heat medium circuit 3 outside the thermochemical energy storage 100 can be connected to one or more heat sources 50 and/or heat sinks 60. As shown in FIG. 1, according to the first embodiment, the energy storage 100 can be connected via the primary heat medium circuit 3 to a heat pump 90, especially to the evaporator 92 of a heat pump 90, as a heat sink 60, through valves 7. Furthermore, an electric heater 52 is permanently integrated into the primary heat medium circuit 3 as a heat source 50. According to one embodiment, this electric heater 52 may be connected to photovoltaic modules to charge the thermochemical energy storage 100 when electrical energy is available, although this is not explicitly shown in FIG. 1. In the operating state depicted in FIG. 1, the valves 7 for connecting the evaporator 92 to the primary heat medium circuit 3 as a heat sink 60 are open.

According to another embodiment, not shown in FIG. 1, the primary heat medium circuit 3 can also be connectable to additional heat sources 50 or heat sinks 60. Suitable heat sources 50 include, in particular, solid fuel, gas, or district heating systems, electric heaters, or other heat sources such as heat exchangers in heating systems. Heat sinks 60, in turn, may include heaters or heat exchangers for heating buildings or hot water, district heating networks, or heat exchangers in other heating devices or systems.

The thermochemical energy storage 100 further comprises a fluid circuit 8, which is connected to the thermochemical cells 1 and designed to guide the carrier gas 9. The fluid circuit 8 is connected to the thermochemical cells 1 via fluid lines 13 in such a way that carrier gas 9 enriched with solvent 12 can be extracted from the respective thermochemical cells 1, and carrier gas 9 depleted of solvent 12 can be supplied back to the thermochemical cell 1.

According to the preferred embodiment, the fluid circuit 8 is closed relative to the surroundings 80 and operates at ambient pressure. In alternative embodiments, the fluid circuit 8 may also have positive or negative pressure relative to the surroundings. In another alternative embodiment, the fluid circuit 8 may be open to the surroundings, i.e., not sealed.

For this purpose, according to the embodiment shown in FIG. 1, a condenser 14 is arranged in the fluid circuit 8 for the condensation of solvent 12 from the carrier gas 9, with the condensed solvent 12 being collected and stored in a condensate container 15.

In an alternative embodiment, the condenser 14 and/or the condensate container 15 can be omitted. The carrier gas 9 can be supplied to the thermochemical cells 1 from outside the energy storage 100, or the carrier gas 9 can be led out of the energy storage 100 from the thermochemical cells 1. Equally, in the absence of a condensate container 15, the solvent 12 can be supplied to it from outside the energy storage 100.

Furthermore, the thermochemical energy storage 100 comprises solvent lines 16 for introducing solvent 12 from the condensate container 15 into the reaction phases 10 of the thermochemical cells 1.

As depicted in FIG. 1, the solvent line 16 includes a controllable pump 17 and controllable valves 18. By selectively controlling the pump 17 and the valves 18, solvent 12 from the condensate container 15 can be delivered to a desired thermochemical cell 1.

In the operational state illustrated in FIG. 1 (discharging of the first thermochemical cell 1a), the valve 18 leading to the first thermochemical cell 1a is open, and the pump 17 is activated, allowing solvent 12 to be supplied to the reaction phase 10 of the first thermochemical cell 1a (depicted as a spray mist of solvent 12). The chemical reaction initiated in the reaction phase 10 results, as described above, in the release of thermal energy, which is then transferred via the heat exchanger 6 to the primary heat medium circuit 3 and supplied to the heat pump 90 as a heat sink 60.

A detailed description of the discharge process of the thermochemical cell 1 is provided below in reference to FIG. 3.

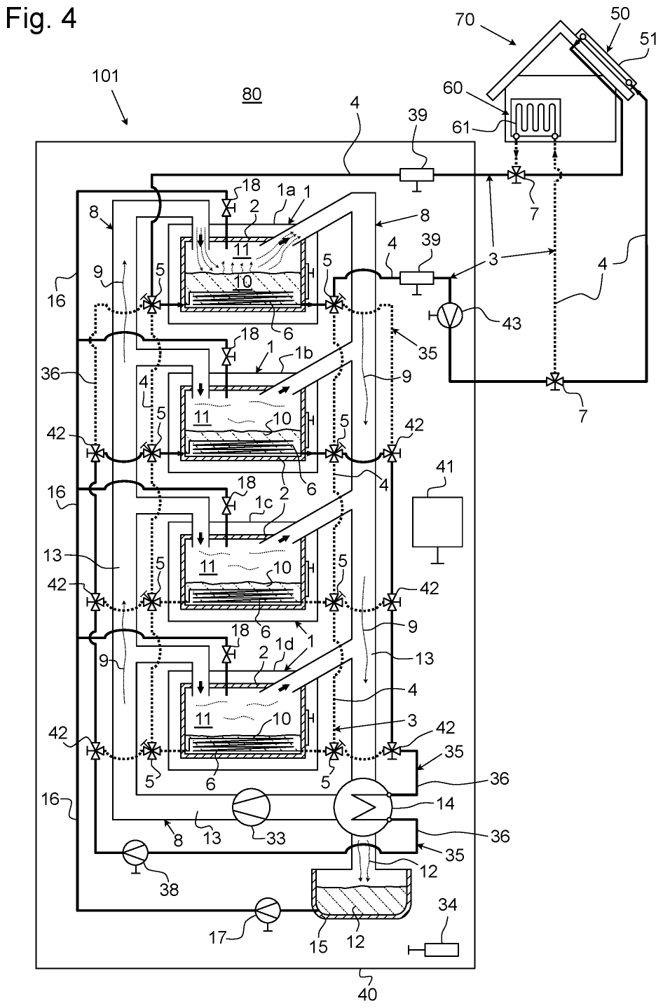

In FIG. 2 and FIG. 3, a thermochemical cell 1 according to two embodiments is depicted in greater detail and in two different operating states. The embodiment of the thermochemical cell 1 shown in FIG. 2 corresponds to the embodiment shown in FIG. 4, while the embodiment depicted in FIG. 3 corresponds to the one shown in FIG. 1. The features of the thermochemical cells 1 described with reference to FIGS. 2 and 3 are mutatis mutandis applicable to the other, unless otherwise specified.

In FIG. 2, the thermochemical cell 1 is shown during the charging process, i.e., while thermal energy is supplied from a heat source 50 to the thermochemical cell 1 or its reaction phase 10 via the primary heat medium circuit 3. For this purpose, the valves 5 are open, and the heat exchanger 6 inside the thermochemical cell 1 is connected to the primary heat medium circuit 3.

As mentioned earlier, the thermochemical cell 1 has a container 2 in which the reaction phase 10 and the gas phase 11 arranged above the reaction phase 10 are contained. The container 2 also preferably has an inert protective layer 20 inside, which protects the container 2 from contact with the reaction phase 10 or the reactant contained therein. According to a preferred embodiment, the protective layer 20 can be formed by a PTFE foil or PTFE lining.

The heat exchanger 6 inside the container 2 is in thermal contact with the reaction phase 10. Thus, during the charging of the thermochemical cell 1, it can transfer thermal energy from the heat transfer medium of the primary heat medium circuit 3 to the reaction phase 10. Conversely, during the discharging of the thermochemical cell 1, it can release thermal energy from the reaction phase 10 to the heat transfer medium of the primary heat medium circuit 3.

In the embodiment of the thermochemical cell 1 shown in FIG. 2, the heat exchanger 6 is designed as a tube heat exchanger 44, which is located inside the thermochemical cell 1, especially within the reaction phase 10. The tube heat exchanger 44 preferably consists of a spiral 45 formed from tubular hoses (or tubes). These hoses/tubes are made of a material inert to the reaction phase 10, preferably PTFE. The heat transfer medium can thus flow directly from the primary heat medium circuit 3 through the spiral 45 of the tube heat exchanger 44, ensuring particularly effective heat transfer between the heat medium and the reaction phase 10. As described later in FIG. 3, the heat exchanger 6 can also be designed as a plate heat exchanger 46.

If thermal energy is now supplied to the reaction phase 10 via the primary heat medium circuit 3 when charging the thermochemical cell 1, the reaction phase 10 absorbs the thermal energy and converts it into heating the solution of reactant and solvent 12. Upon reaching a critical temperature, solvent 12 begins to desorb from the solution in the reaction phase 10, transitioning into the gas phase 11 above, or enriching the carrier gas 9 contained therein with solvent 12. The carrier gas 9 enriched with solvent 12 is then discharged from the thermochemical cell 1, as described previously in FIG. 1, and directed through the condenser 14, where the solvent 12 condenses again and is collected in the solvent container 15.

In order to efficiently transport the carrier gas 9 enriched with solvent 12 in the gas phase 11 inside the thermochemical cell 1 via the fluid circuit 8, the thermochemical cell 1 has a fluid inlet 21 and fluid outlet 22, each connected to the fluid circuit 8. Both the fluid inlet 21 and the fluid outlet 22 open directly into the gas phase 11 in the container 2. The direct opening of the fluid inlet 21 and fluid outlet 22 into the gas phase 11 allows for an efficient exchange of the enriched carrier gas 9 in the gas phase 11 with fresh carrier gas 9 from the fluid circuit 8. Additionally, it prevents solution from the reaction phase 10, containing reactants, from entering the fluid circuit 8 and contaminating the solvent 12.

As further evident in FIG. 2, the fluid inlet 21 has an inlet opening 23, and the fluid outlet 22 has an outlet opening 24. Both the inlet opening 23 and the outlet opening 24 are provided in the top 25 of the container 2 and thus directly connect to the gas phase 11. By having the inlet opening 23 directly provided in the top 25 of the container 2, the carrier gas 9 entering the thermochemical cell 1 from the fluid circuit 8 through the fluid inlet 21 can be directed towards the reaction phase 10, as schematically depicted in FIG. 2. Equally, the outlet opening 24 provided in the top 25 of the container 2 can direct the carrier gas 9 from the container 2, from the reaction phase 10 towards the fluid outlet 22.

By directing the incoming carrier gas 9 directly towards the reaction phase 10, the evaporating solvent 12 from the reaction phase 10 can be quickly replaced by fresh carrier gas 9, without causing a significant increase in the concentration of solvent 12 within the gas phase 11. Such an increase in concentration or saturation of the carrier gas 9 would lead to a noticeable reduction in efficiency in the absorption and desorption of solvent 12 from the reaction phase 10. It is also crucial during the discharge of the enriched carrier gas 9 from the container 2 that the carrier gas 9 is directed without prolonged residence time directly from the reaction phase 10 towards the outlet opening 24 and through the fluid outlet 22 out of the container 2.

Additionally, the fluid inlet 21 has a first fluid guiding section 26 to redirect the carrier gas 9 purposefully towards the reaction phase 10 before exiting the inlet opening 23. The fluid guiding section 26 is preferably designed, according to one embodiment, as a leg 27 extending from the top 25 of the container 2 towards the interior of the container 2 in the direction of the reaction phase 10. In alternative embodiments, the fluid guiding section 26 may also extend towards the exterior of the container 2. Preferably, the fluid guiding section 26 directly connects to the inlet opening 23 in the top 25 of the thermochemical cell 1 or its container 2.

To ensure that the carrier gas 9 is reliably directed towards the reaction phase 10 as it passes through the fluid inlet 21 via the fluid guiding section 26, the fluid guiding section 26 has, in longitudinal section as shown in FIGS. 2 and 3, a tangent line 28 that penetrates the thermochemical cell 1 from its top 25 towards its bottom 30, intersecting the reaction phase 10 in the process. In the illustrated embodiment, the tangent line 28 runs normal or perpendicular to the top 25 of the container 2. In alternative embodiments, the tangent line may also run obliquely from the inlet opening 23 towards the bottom 30 of the container. In yet another embodiment, the fluid guiding section 26, in longitudinal section, may have a plurality of tangents intersecting the reaction phase 10, for example, if the fluid guiding section 26 has a curvature.

In the same manner as described the first fluid guiding section 26 earlier, the fluid outlet 22 has a second fluid guiding section 29 to guide the carrier gas 9 before it exits the container 2 through the outlet opening 24 from the reaction phase 10 towards the fluid outlet 22. In another embodiment not depicted in the figures, the second fluid guiding section 29 may also have, as previously described for the first fluid guiding section 26, a tangent in longitudinal section intersecting the reaction phase 10.

In FIG. 3, the thermochemical cell 1 is shown during the discharging process, i.e., when solvent 12 is supplied from the solvent container 15 to the reaction phase 10. The solvent container 15, which is connected to the thermochemical cell 1 via the solvent line 16 and the valve 18, is not shown for simplicity.

The solvent line 17 connected to the thermochemical cell 1 has a solvent outlet 19 inside the container 2. When the valve 18 is open and the pump 17 is activated, solvent 12 is released onto the reaction phase 10 from the solvent outlet 19. The release of the solvent 12 preferably occurs in finely distributed form, such as a spray mist. For this purpose, according to an embodiment not shown in detail, the solvent outlet 19 may have a nozzle. Alternatively, the solvent outlet can also be formed by an open pipe end.

When the solvent 12 is released onto the reaction phase 10 during the discharge of the thermochemical cell 1, the solution of reactants in the solvent 12 leads to the exothermic reaction described above. The reaction phase 10 is heated by the released thermal energy. Once again, the heat exchanger 6 is connected to the primary heat medium circuit 3 through open valves 5, allowing the heat transfer medium to flow through. This medium carries away the thermal energy from the reaction phase 10 and can deliver it to a heat sink 60, as described earlier in FIG. 1.

In contrast to FIG. 2, the heat exchanger 6 in the embodiment shown in FIG. 3 is a plate heat exchanger 46, which is positioned above the bottom 30 of the container 2 or the thermochemical cell 1. In other embodiments, the plate heat exchanger 46 may also be arranged additionally or alternatively on the side walls 31 of the container. The heat transfer between the heat transfer medium and the reaction phase 10 occurs over the entire surface covered by the plate heat exchanger on the bottom 30 and/or the side walls 31.

Furthermore, a level sensor 32 is provided on the container 2 of the thermochemical cell 1, which can determine the level of the solution in the reaction phase 10 inside the container 2. According to one embodiment, the level sensor 32 can be an electromagnetic or capacitive level sensor that can determine the fill level inside the container 2 without direct contact. Monitoring the fill level can provide information about the charging status of the thermochemical cell, where a high fill level of solution in the reaction phase 10 may be associated with a discharged thermochemical cell 1, while a low fill level may be associated with a charged thermochemical cell 1.

The level sensor 32 is preferably positioned between a side wall 31 and the protective layer 20 of the container 2 of the thermochemical cell 1. In alternative embodiments, the level sensor 32 can also be attached to the outer or inner side of the side wall 31 or the protective layer 20 of the container 2.

All features of the thermochemical cells 1 of the thermochemical energy storage 100 described in FIGS. 2 and 3 are also applicable to FIGS. 1 and 4, even if these features, along with their reference numbers, are not explicitly depicted.

In FIG. 1, it is further shown that the fluid circuit 3 also includes a circulation fan 33, which can further improve the exchange of carrier gas 9 in the thermochemical cells 1 by increasing the circulation speed.

The thermochemical energy storage 100 has a secondary heat medium circuit 35 connected to the condenser 14. The condenser 14 is connected to a low-temperature source 37 via heat medium lines 36. The low-temperature source 37 serves to balance and absorb thermal energy from the condensation of the solvent 12, maintaining efficient condensation in the condenser 14. Additionally, a heat medium pump 38 is provided in the secondary heat medium circuit 35 to support the circulation of the heat transfer medium.

According to a preferred embodiment, oil is used as the heat transfer medium in both the primary heat medium circuit 3 and the secondary heat medium circuit 35. In alternative embodiments, any other suitable heat transfer medium can also be used.

In the primary heat medium circuit 3, temperature sensors 39 are also provided, allowing the temperature of the heat transfer medium to be measured before entering a heat exchanger 6 of the thermochemical cells 1 and after exiting the heat exchanger 6 of the thermochemical cells 1. By taking the difference between the measured temperatures of the temperature sensors 39, the temperature spread during the charging or discharging of the thermochemical cells 1 can be determined. This information can provide insights into the charging or discharging capacity and the charging status of the thermochemical cells 1.

Furthermore, according to one embodiment, the thermochemical energy storage 100 may have a safety tray 40 with a leakage detector 34, wherein all thermochemical cells 1a, 1b, 1c, 1d are accommodated in the safety tray 40. In the event of a leakage of solution or reactants from the containers 2 of the thermochemical cells 1, this solution is collected by the safety tray 40, preventing a leakage from the thermochemical energy storage 100. The leaked solution can then be detected by the leakage detector 34, and an appropriate signal can be issued to the user.

The thermochemical energy storage 100 further includes a control device 41, which is programmed to control the valves 5, 7 of the primary heat medium circuit 3 based on the state of charge of the thermochemical cells 1 for the extraction or supply of thermal energy. The control device 41 is connected to the valves 5, 7 of the primary heat medium circuit 3, and the connection can be through control lines or wirelessly, although this is not specifically depicted in the figures.

Equally, the control device 41 is connected to temperature sensors 39 for detecting the temperatures of the heat transfer medium in the primary heat medium circuit 3. The control device 41 is also programmed to, upon exceeding a predetermined threshold temperature of a heat source 50 connected to the primary heat medium circuit 3, control the valves 5, 7 of the primary heat medium circuit 3 to charge a partially or non-charged thermochemical cell 1. Depending on the state of charge of the thermochemical cells 1a, 1b, 1c, 1d, the control device 41 can thus select the most suitable thermochemical cell 1 to transfer thermal energy from the heat source 50 and switch the valves 5, 7 accordingly. As shown in further detail in FIG. 4, when a threshold temperature is reached in the solar system 51, the first thermochemical cell 1a has been selected for charging and connected to the primary heat medium circuit 3, as it has the lowest state of charge (highest fill level).

Furthermore, the control device 41 is connected to the fill level sensors 32 of the thermochemical cells 1 and is programmed to read the fill level sensors 32. When the fill level in a thermochemical cell 1 falls below a predefined threshold, the control device 41 outputs a signal indicating the complete charge of that thermochemical cell 1. Upon detecting the complete charge of a thermochemical cell 1, the control device 41 can store this charging status. When thermal energy is requested from the energy storage 100, the control device can connect this fully charged thermochemical cell 1 to discharge with the heat sink 60 by controlling the valves 5, 7. Alternatively, the signal from the control device 41 can be output to the user or another control unit to indicate that a thermochemical cell 1 has been fully charged. In this regard, according to another embodiment not shown in the figures, the thermochemical energy storage 100 may have an optical display means, such as a display, LED, etc., or digitally transmit signals to other devices or display units.

Similarly, as described above, the control device 41 is connected to the temperature sensors 39 and further programmed, in the case of the complete charge of a thermochemical cell 1, to determine the temperature spread of the heat transfer medium during the charging of the thermochemical cell 1 from the detected values of the temperature sensors 39. If the temperature spread falls below a predefined temperature spread threshold, the control device 41 can then control the valves 5, 7 to disconnect the fully charged thermochemical cell 1 from the primary heat medium circuit 3. As shown in FIGS. 1 and 4, the fourth thermochemical cell 1d, for example, represents a fully charged thermochemical cell 1 (with a low fill level), which is disconnected from the primary heat medium circuit 3. Upon request for thermal energy from the energy storage 100, the control device can connect the fully charged thermochemical cell 1 directly, or indirectly through a heat exchanger, to a heat sink 60 by controlling the valves 5, 7. The second and third thermochemical cells 1b, 1c, on the other hand, are partially charged or discharged.

The control device 41 is again further connected to the pump 17 in the solvent line 16 and programmed to, upon receiving a signal for the release of thermal energy from the energy storage 100 to a heat sink 60, control the pump in the solvent line 16 to supply solvent 12 from the condensate container 12 to the reaction phase 10 of a charged or partially charged thermochemical cell 1. This supply of solvent 12 to the reaction phase 10 corresponds, once again, to the operational state of discharging a thermochemical cell, as shown in FIG. 3 and FIG. 1.

The control device 41 is further connected to a heat transfer medium pump 43 in the primary heat medium circuit 3 and programmed to control the flow rate of heat transfer medium in the heat medium circuit 3 by controlling the heat transfer medium pump 43. In particular, the flow rate of heat transfer medium to the connected heat source 50 and to the heat exchangers 6 of the thermochemical cells 1 can be regulated. For example, the heat transfer medium supplied to the thermochemical cell 1 can be maintained in a preferred temperature range. According to an embodiment not shown in the figures, this can be achieved, for instance, by controlling the heat transfer medium pump 43 using pulse width modulation (PWM).

According to FIG. 1, a system 200, equally according to the invention, consisting of the thermochemical energy storage 100 and the heat pump 90 is also shown. The heat pump 90 includes a condenser 91 for releasing energy to a heat sink and an evaporator 92 for absorbing energy from a heat source. The evaporator 92 of the heat pump 90 is coupled as a heat sink 60 to the primary heat medium circuit 3 of the thermochemical energy storage 100.

In addition, the heat pump 90 includes a heat exchanger 93 coupled with the evaporator 92, which is connected to the primary heat medium circuit 3 of the thermochemical energy storage 100.

By coupling the evaporator 92 of the heat pump 90 with the thermochemical energy storage 100, even under extremely cold environmental conditions where the heat pump 90 typically loses efficiency, the efficiency can be maintained at a high level through the supply of thermal energy. This allows for a reduction in the external supply of energy, such as electrical power.

The heat pump 90 can then be coupled to a heat sink, such as a building heating system, hot water heating system, or the like, via the condenser 91. However, this is not further illustrated in the figures.

Instead of the thermochemical energy storage 100 shown in FIG. 1, the system 200 can also include the thermochemical energy storage 101 depicted in FIG. 4.

In FIG. 4, a thermochemical energy storage 101 according to a second embodiment of the invention is shown. For the thermochemical energy storage 101 in FIG. 4, all the features described previously with reference to FIG. 1 apply, unless otherwise stated below.

As evident from FIG. 4, the thermochemical energy storage 101 also features four thermochemical cells 1, labelled as the first, second, third, and fourth thermochemical cells 1a, 1b, 1c, 1d, respectively. With regard to these thermochemical cells 1a, 1b, 1c, 1d, reference is also made to the above statements based on FIGS. 2 and 3.

As depicted in FIG. 4, the primary heat medium circuit 3, through valves 7, can be directly or indirectly (e.g., through a corresponding upstream heat exchanger) connected to a building heating system 61 in a building 70 as a heat sink 60. It is also connectable, via valves 7, to a solar system 51 in the building 70 as a heat source 50. In the operational state shown in FIG. 4, the valves 7 are open to connect the solar system 51 as a heat source 50, and the building heating system 61 is disconnected from the heat medium circuit 3, as represented by dashed heat transfer lines 4.

In the operational state depicted in FIG. 4 (charging the first thermochemical cell 1a), all valves 18 are closed, and no solvent 12 is supplied to the thermochemical cells 1. Instead, thermal energy from the solar system 51, acting as a heat source 50, is transferred through the primary heat medium circuit 3 to the first thermochemical cell 1a. In this cell, the reaction phase 10 is heated, and the liberated solvent 12, released into the gas phase 11, is removed from the thermochemical cell 1a by circulating the carrier gas in the fluid circuit 8 and condensed in the condenser 14.

A detailed description of the charging process of the thermochemical cell 1 is provided above in reference to FIG. 2, to which reference is made in this context.

As already described for FIG. 1, the thermochemical energy storage 101 in FIG. 4 also has a secondary heat medium circuit 35, which is connected to the condenser 14. According to the second embodiment of the energy storage 101, the condenser 14 is now not connected to an external low-temperature source 37. Instead, the secondary heat medium circuit 35 can be connected to a heat exchanger 6 in one or more thermochemical cells 1 by controllable valves 42 and by controlling the valves 5. According to an alternative embodiment, the secondary heat medium circuit 35 can also be directly connected to the heat exchangers 6 of the thermochemical cells 1 via the valves 5, although this is not specifically illustrated in the figures.

As shown in FIG. 4 and described earlier, the first thermochemical cell 1a is connected to the solar system 51 as a heat source 50 via the primary heat medium circuit 3 and is charged by supplying thermal energy to the reaction phase 10. The solvent 12 vaporized from the reaction phase 10 into the gas phase 11 is removed through the fluid circuit 8 and condensed in the condenser 14 from the carrier gas 9.

The thermal energy generated in the condenser 14 is now supplied to the second thermochemical cell 1b, connected via the valves 42, 5, or its heat exchanger 6, through the secondary heat medium circuit 35. This process preheats the second thermochemical cell 1b simultaneously with the charging of the first thermochemical cell 1a.

In this way, after the first thermochemical cell 1a is fully charged, the second thermochemical cell 1b can be disconnected from the secondary heat medium circuit 35 by controlling the valves 5, 42, and connected to the primary heat medium circuit 3 for charging. Similarly, in subsequent steps, the third thermochemical cell 1c can then be connected to the secondary heat medium circuit 35 for preheating.

Specifically, the control device is programmed to select the thermochemical cells 1 based on their state of charge for preheating and/or charging. In this way, the thermochemical cells 1 designated for charging can always be charged with high efficiency.

As shown in FIG. 4, the thermochemical energy storage 101 can be used in the discharging state as a building heating system or as a heat source for a building heating system 61. Simultaneously, in the charging state, the thermochemical energy storage 101 can function as a seasonal energy storage, especially for the intermediate storage of thermal energy from a solar system 51.

According to further embodiments, the thermochemical energy storage 101 can also be used as a seasonal energy storage or for the intermediate storage of thermal energy from thermal power plants, especially district heating power plants, etc.

The features presented in FIGS. 1 to 4 and the embodiments can be exchanged and combined freely between the embodiments, unless otherwise specified.

1-26. (canceled)

27. A thermochemical energy storage, comprising:
one or more thermochemical cells, each comprising a container in which, in an operating state, a reaction phase comprising at least one reactant and solvent, and a gas phase, comprising a carrier gas enriched with solvent, is formed;
a primary heat medium circuit with a heat transfer medium for removing and introducing thermal energy from the thermochemical energy storage or in the thermochemical energy storage;
a fluid circuit for diverting the carrier gas from at least one of the thermochemical cells and for introducing the carrier gas in at least one of the thermochemical cells;
at least one solvent line for introducing solvent into the reaction phase of at least one of the thermochemical cells;
whereby the reactant is selected from a group consisting of salts, hydroxides, carbonates and ionic liquids, so that when the solvent is fed into the reaction phase of at least one of the thermochemical cells, due to an exothermic reaction of the reactant with the solvent, thermal energy is released to the heat transfer medium in the primary heat medium circuit and when heat is supplied via the heat transfer medium to the reaction phase of at least one of the thermochemical cells, solvent is transferred from the reaction phase into the gas phase; and
wherein the container of the at least one thermochemical cell comprises a fluid inlet and a fluid outlet connected to the fluid circuit, which end in the gas phase in the container, respectively.

28. The thermochemical energy storage according to claim 27, wherein the thermochemical energy storage has a condenser in the fluid circuit for condensation of solvent from the carrier gas.

29. The thermochemical energy storage according to claim 28, wherein the thermochemical energy storage has a condensate container for storing the solvent condensed in the condenser from the carrier gas, and that the solvent line is connected to the condensate container.

30. The thermochemical energy storage according to claim 27, wherein the fluid circuit is closed with respect to the environment and has ambient pressure.

31. The thermochemical energy storage according to claim 27, wherein the fluid inlet has an inlet opening and the fluid outlet has an outlet opening, whereby the inlet and outlet opening are each provided in the top of the container of the at least one thermochemical cell.

32. The thermochemical energy storage according to claim 27, wherein the fluid inlet has a first fluid guide section, the first fluid guide section being designed to deflect the carrier gas guided in the fluid circuit in the direction of the reaction phase.

33. The thermochemical energy storage according to claim 32, wherein the first fluid guide section comprises at least one tangent in longitudinal section, which penetrates the respective thermochemical cell from its top in the direction of its bottom.

34. The thermochemical energy storage according to claim 27, wherein a circulation fan is arranged in the fluid circuit.

35. The thermochemical energy storage according to claim 27, wherein:
the one or more thermochemical cells comprises at least one heat exchanger connected to the primary heat medium circuit; and
the heat exchanger is in contact with the reaction phase.

36. The thermochemical energy storage according to claim 35, wherein one of:
the heat exchanger is a tubular heat exchanger which is arranged within the reaction phase of the respective thermochemical cell; and
the heat exchanger is a surface heat exchanger which is arranged at least one of:
above the bottom; and
on at least one side wall of the respective thermochemical cell.

37. The thermochemical energy storage according to claim 28, wherein the thermochemical energy storage has a secondary heat medium circuit, via which the condenser can be connected to a low-temperature source.

38. The thermochemical energy storage according to claim 37, wherein the condenser is configured to be connected via the secondary heat medium circuit to one or more of the thermochemical cells as a low-temperature source.

39. The thermochemical energy storage according to claim 27, wherein a filling level sensor is provided on the container of the one or more thermochemical cells.

40. The thermochemical energy storage according to claim 27, wherein the thermochemical energy storage has a safety tank with a leakage detector, in which the one or more thermochemical cells are accommodated.

41. The thermochemical energy storage according to claim 27, wherein the primary heat medium circuit comprises controllable valves for connecting one or more of the thermochemical cells to a heat source or heat sink.

42. The thermochemical energy storage according to claim 27, wherein the thermochemical energy storage has a control unit which is programmed to control the valves of at least one of the primary heat medium circuit and the secondary heat medium circuit in dependence of the state of charge of the thermochemical cells for the removal or supply of thermal energy.

43. The thermochemical energy storage according to claim 42, wherein the control device is further programmed to at least one of:
actuate the valves of the primary heat medium circuit for charging an uncharged or only partially charged thermochemical cell in case a predetermined threshold temperature of a heat source connected to the primary heat medium circuit is exceeded;
read out the level sensors of the thermochemical cells and, in case the fill level in a thermochemical cell falls below a predetermined fill level threshold value, to output a signal which indicates the complete charging of that thermochemical cell;
in the case of a fully charged thermochemical cell, determine the temperature spread of the heat transfer medium when charging the thermochemical cell, and, if the temperature spread falls below a predetermined temperature spread threshold value, to actuate the valves in such a way as to disconnect the fully charged thermochemical cell from the primary heat transfer medium circuit; and
upon receipt of a signal to release heat from the energy storge to a heat sink, actuate a pump in a solvent line to supply solvent from the condensate container to the reaction phase of a charged or partially charged thermochemical cell.

44. A system comprising a thermochemical energy storage according to claim 27, comprising:
a heat pump having a condenser for delivering energy to a heat sink and an evaporator for receiving energy from a heat source;
wherein the evaporator of the heat pump is coupled as a further heat sink to the primary heat medium circuit of the thermochemical energy storage.

45. The system according to claim 44, wherein the heat pump comprises a heat exchanger coupled to the evaporator, which is connected to the primary heat medium circuit of the thermochemical energy storage.

46. A method of using the thermochemical energy storage according to claim 27, comprising:
operating the thermochemical energy storage in a building for heating or as buffer storage.
